(19) United States
(12) Patent Application Publication
(10) Pub. No.: US 2017/0045614 A1
(43) Pub. Date: Feb. 16, 2017

(54) ULTRASONIC RANGING SENSORS

(71) Applicant: Daniel N. Harres, Belleville, IL (US)

(72) Inventor: Daniel N. Harres, Belleville, IL (US)

(21) Appl. No.: 14/825,830

(22) Filed: Aug. 13, 2015

(51) Int. Cl. G01S 15/42; G01S 7/529; G01S 15/10

(52) U.S. Cl. CPC G01S 15/42; G01S 15/10; G01S 7/529

(57) ABSTRACT

An apparatus and method for ultrasonic ranging that allows for the determination of both longitudinal and lateral distances therefore, solving the problem of determining how far to the left or right an object is using such a sensing apparatus by providing variable gain in the receivers, by varying the number of pulses from the transmitter, or by varying the threshold. For example, a digital potentiometer can be used in cascade with each of the two receivers, controlled by the microcontroller, so that the gain can be increased as the time-since-transmission increases. Likewise, the number of pulses can be increased with increasing time-since-transmission, and the threshold can be decreased with increasing time-since-transmission.

### BACKGROUND

Field

This technology relates generally to sensors for guidance systems, and, more particularly, to detection of obstacles in the path of a robotic system using signals received by sensors for guidance of the robotic system.

Background Art

Ultrasonic ranging sensors can be used as a means of determining distance to an object. This is particularly useful for automated robotic systems. Typically, a transmitter, capable of producing ultrasonic sound waves, generates an integer number of cycles at the ultrasonic frequency. The time required for the sound to exit the transmitter, strike the obstacle, and reflect to an ultrasonic receiver located near the transmitter can be referred to as time of-flight (TOF) and is a fairly reliable parameter for distance estimation. By dividing the TOF by 2 (to account for the round trip traveled) and multiplying by the speed of sound (˜1100 feet per second for standard temperature and pressure) the distance to the obstacle can be determined.

A single transmitter and single receiver will determine the distance from transmitter/receiver to obstacle. However, the estimate is strictly a range-to-target and gives no information about whether the obstacle is to the left or right of the center line of sight, or how far to the left or right of the center line of sight. For example, a TOF measurement of 3.6 milliseconds would mean that the obstacle is approximately 2 feet away. However, the obstacle could be anywhere along an arc of radius 2 feet. With no additional information, the obstacle could be directly in front of the robot (along the center line of sight) or far to the left or right of the robot.

Various approaches have been implemented to overcome this absence of bearing information. One approach is to mount an ultrasonic transmitter/receiver pair on a rotating platform with a servo that can sweep back and forth. With multiple “soundings”, the idea is that the information can be combined in a way that produces the additional bearing information. This approach has a severe limitation that each time the transmitter sends out a pulse train, it must then wait for a significant length of time before sending the next pulse train at the next servo increment. This is because sending a pulse train too soon after a previous pulse train can result in ambiguity about which pulse train caused the reflection that the receiver observes and therefore what TOF to use for the distance estimate. As a result of this timing spacing, as well as a possible limitation in the servo slew rate, a complete scan swing will likely require more than a second, much too long for a fast-moving robot to make collision-avoidance decisions.

Another approach is to use LEDs/photoreceivers to the left and right of the ultrasonic transmitter/receiver pair. The left and right LED are each flashed individually and the amplitudes of the received signals are compared to determine whether the obstacle is to the left or right. This method has a number of limitations. First, the reflected signals are generally weak, making signal acquisition at distances of more than a few feet quite difficult. Also, the amplitude difference between the two sets of signals is typically low. Finally, the determination of the actual lateral distance to the left or right (as opposed to just a binary decision about whether the object is to the left or right) is extremely unreliable.

The ultrasonic transmitter and receiver each have a field-of-view (FOV). This is an angle from the normal to the robot's front. Stated another way, the FOV, is combined angles on either side of the center line of sight within which a sensor can detect. Typically, this is treated as a boundary, beyond which the transmitter's power is zero and the receiver's sensitivity is zero. In practice, the transmitter's power and the receiver's sensitivity vary gradually from a maximum at the normal to the robot front and the FOV is defined as some limit, usually half-maximum, after which the transmitter's power and the receiver's sensitivity are below this limit. The FOV is important because, for a too-large FOV obstacles well outside of the vehicle's path will be detected. To further complicate the FOV matter, the required FOV varies with the distance from the vehicle. At short distances, say, a distance approximately the same as the width of the vehicle, the FOV may need to be as much as ±45°, whereas at long distances (distances much greater than the width of the vehicle) the required FOV will be less than ±10°.

The technology as disclosed herein addresses the shortcomings outlined above and other technological challenges.

### BRIEF SUMMARY

The technology as disclosed herein is an apparatus and method for ultrasonic ranging that allows for the determination of both longitudinal and lateral distances therefore, solving the problem of determining how far to the left or right an object is using such a sensing apparatus.

A new approach to ultrasonic ranging allows the determination of both longitudinal (in the direction of the normal to the robot front) and lateral (parallel to the robot front) distances. It therefore solves the problem of determining how far to the left or right an object is. It also eliminates the variable FOV problem by observing how far in the lateral direction the obstacle is and discarding those reflections that occur outside the critical FOV. The new approach adds a second receiver. The receivers are located an equal distance from the left and right of the transmitter, as illustrated in FIG. 5.

The ultrasonic wave is transmitted as before and, upon reflection from an obstacle (in the FIG. 1 example, a chair leg) the reflection arrives at both receivers (RX1 and RX2 in FIG. 1). However, there is a time difference in when the signal arrives at the two receivers. In the example, the reflected signal arrives at RX2 sooner than it arrives at RX1.

The range problem can be mitigated by providing variable gain in the receivers, by varying the number of pulses from the transmitter, or by varying the threshold. For example, a digital potentiometer can be used in cascade with each of the two receivers, controlled by the microcontroller, so that the gain can be increased as the time-since-transmission increases. Likewise, the number of pulses can be increased with increasing time-since-transmission, and the threshold can be decreased with increasing time-since-transmission.

These and other advantageous features of the present invention that address the shortcoming outlined above will be pointed out herein below.

### BRIEF DESCRIPTION OF THE DRAWINGS

For a better understanding of the present invention, reference may be made to the accompanying drawings in which:

FIG. 1 is an illustration of transmitted power that is reflected from an obstacle and received by receivers;

FIG. 2 is an illustration of an AM demodulator for extracting reflection amplitude;

FIG. 3 is an illustration of ultrasonic receiver waveforms with corresponding demodulated outputs;

FIG. 4 is an illustration of an ultrasonic receiver waveforms and their corresponding comparator waveforms

FIG. 5 is an illustration of an ultrasonic receiver analog and comparator waveforms with expanded timescale;

FIG. 6 is an illustration of a digital implementation of the TOF difference;

FIG. 7 Is an illustration of a TOF Difference Limit as a Function of TOF Sum where Values Above Curve Are Out-Of-Bound;

FIG. 8 is an illustration of a transmit, a receive and AM-demodulated received;

FIG. 9 is an illustration of a more accurate timing measurement by using the centers of the waveforms; and

FIG. 10 is an illustration of an implementation of the technology.

While the invention is susceptible to various modifications and alternative forms, specific implementations thereof are shown by way of example in the drawings and will herein be described in detail. It should be understood, however, that the drawings and detailed description presented herein are not intended to limit the invention to the particular implementation disclosed, but on the contrary, the intention is to cover all modifications, equivalents, and alternatives falling within the scope of the present invention as defined herein and by the appended claims.

### DETAILED DESCRIPTION OF INVENTION

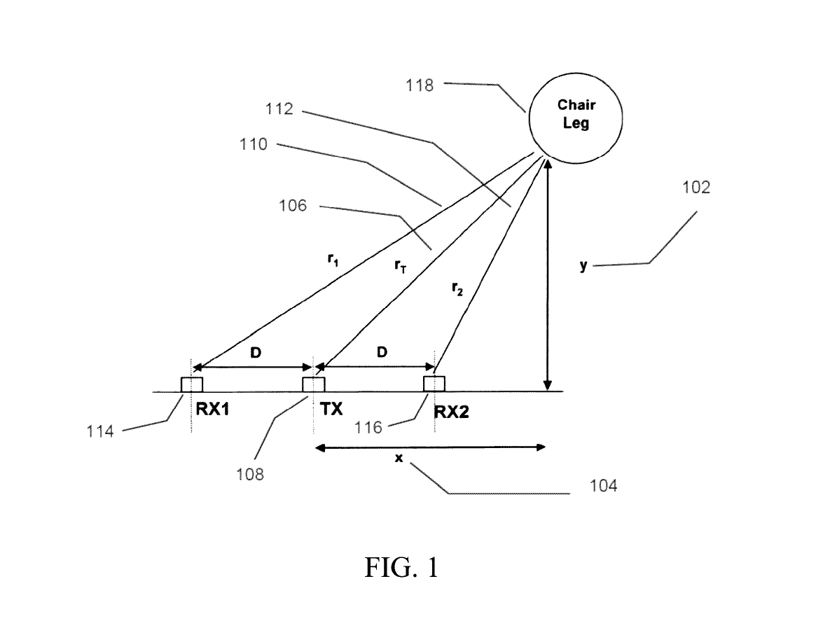

According to the embodiment(s) of the present invention, various views are illustrated in FIG. 1-10 and like reference numerals are being used consistently throughout to refer to like and corresponding parts of the invention for all of the various views and figures of the drawing. Also, please note that the first digit(s) of the reference number for a given item or part of the invention should correspond to the Fig. number in which the item or part is first identified.

One embodiment of the present technology comprising two or more ultrasonic sensing receivers having variable gain teaches a novel apparatus and method for range sensing.

The details of the invention and various implementations can be better understood by referring to the figures of the drawing. Referring to FIG. 1, the vector y 102, and a vector x 104, along with the vector 106 from transmitter 108 or 110 and 112 from either of the two receivers 114 and 116 to the obstacle 118, form right triangles. By defining the time for the ultrasonic wave to travel from transmitter 108, TX, to the obstacle 118 and back to receiver 114, RX1, as TOF1 and the path from TX-to-obstacle-to-RX2 as TOF2, it can be shown that the following equations for the lateral and longitudinal distances hold:

$$\begin{matrix}x = \frac{{c}^{2}}{4} ( TOF 1 - TOF 2 ) ( TOF 1 + TOF 2 ) & ( 1 ) \\ y = \frac{c}{4} ( TOF 1 + TOF 2 ) \sqrt{1 - {\frac{{c}^{2}}{4} [ \frac{TOF 1 - TOF 2}{D} ]}^{2}} & ( 2 )\end{matrix}$$

In these equations, c is the speed of sound and D is the distance from transmitter to either of the two receivers. As Equations 1 and 2 show, accurate measurements of the two times-of-flight, TOF1 and TOF2, are sufficient to produce precise estimates of x and y.

One method of implementation for both transmitting and receiving ultrasonic sound is to use piezo devices. The piezo actuator (transmitter) changes its shape when subjected to an electrical voltage, pushing the sound wave out. The piezo resonates when the frequency is matched to the acoustical cavity of the device. Thus, it generates a relatively large amount of acoustical power, but over a very narrow range of frequencies. For ultrasonic ranging, this is usually a desirable situation.

For ultrasonic receivers, one implementation is to use a piezo device as well. The piezo material produces an electrical voltage when its physical walls are deformed at the device's resonant frequency. It is basically the same device as the actuator and, in fact, some devices are sold as both transmitter and receiver, with an electrical circuit that is multiplexed between driver and amplifier. Piezo-based ultrasonic receivers have little advantage over more conventional microphones except for the fact that their resonance means naturally filter out most of the sound except that which is at their resonant frequency. Also, many microphones are not candidates for ultrasonic operation due to their limited frequency range.

When implementing the technology disclosed herein using microphones for XY ultrasonic ranging, as will be shown later, the two receivers can be located less than a wavelength from each other. Even at the relatively low ultrasonic frequency of 25 kHz, half a wavelength is only:

$$λ = \frac{c}{f} = \frac{13500}{25000} = 0.54 inches \qquad ( 3 )$$

This is the center-to-center spacing, so the receiver device can have a width less than this amount. Commercially available piezo receivers can have a diameter of 0.65 inches, making them too large for such spacing. Surface-mounted microphones are now available that are small enough to meet this requirement and have good sensitivity at 25 kHz. In addition they are relatively inexpensive.

One additional issue that arises when implementing the technology with microphones, rather than piezo, for the ultrasonic receivers is that microphones have a response over the entire audio range and will therefore pick up the sound of motors and other audio-range sounds. This can cause false alarms and can saturate the amplification chain following the microphone. To avoid these problems, a bandpass filter can be used as the first stage in the amplification chain.

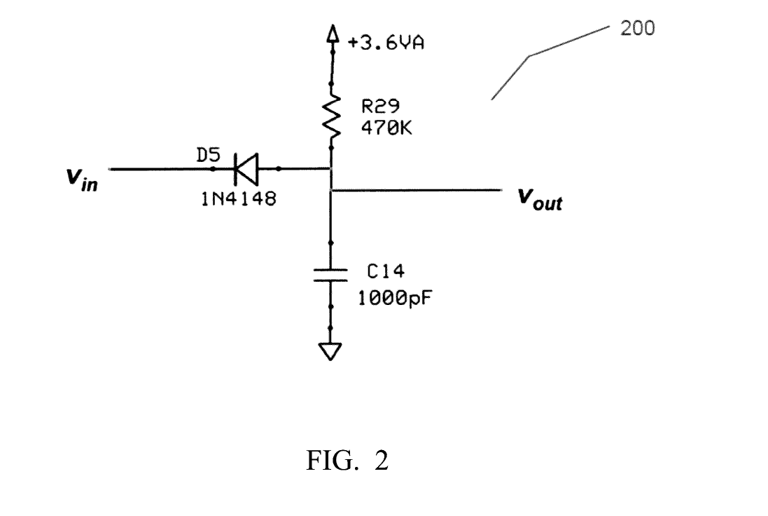

The reflected signal is basically an amplitude-modulated signal, where the “carrier” is the ultrasonic frequency and the envelope is proportional to the amplitude of the reflection. Therefore, an amplitude-modulation (AM) demodulator 200, like the one shown in FIG. 2, serves to extract the reflection amplitude.

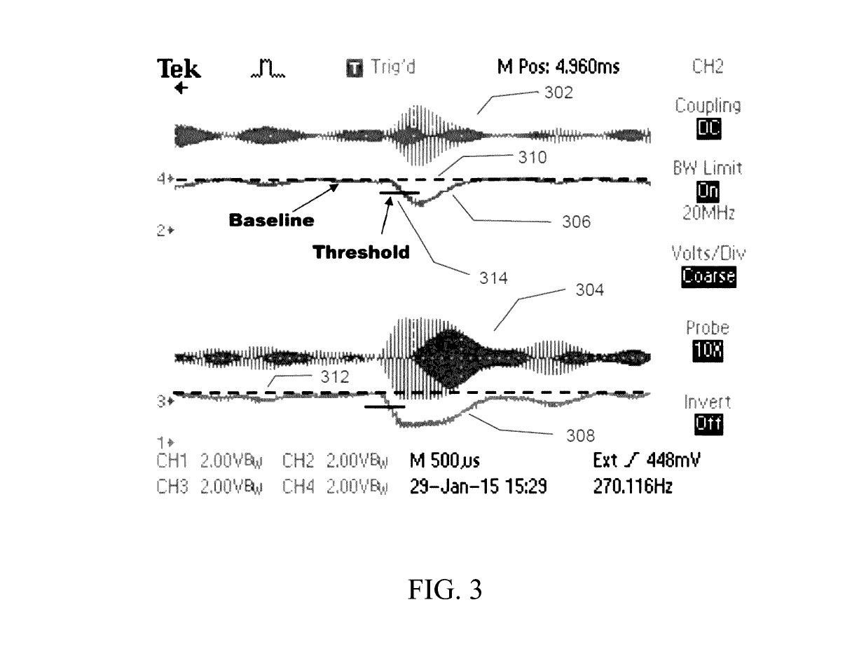

The idea is that inputs more negative than (νₒᵤₜ−ν_{D}) will turn the diode on, resulting in a still lower νₒᵤₜ, while inputs greater than (νₒᵤₜ−ν_{D}) will turn the diode off, resulting in just a very slow charging of the capacitor through the resistor. AM demodulation is one approach to implement ultrasonic detection. Actual results for two such ultrasonic ranging receivers are shown in FIG. 3. The received signals 302 and 304 are shown above their demodulated envelopes 306 and 308 respectively.

A simple way to determine time-of-flight is to generate the AM-demodulated envelope of an ultrasonic receiver response and compare it to some threshold 314. For example, in FIG. 3, the two envelope waveforms 306 and 308 descend below their respective baselines 310 and 312 by a little less than 1 volt near mid-screen. A comparator, with threshold set at about 0.3 volts below baseline, would detect the object corresponding to these “dips”.

One issue with using the AM demodulation detection method is that the TOF estimate changes as the threshold changes. In the FIG. 3 example, the use of a threshold at 0.2 volts below baseline would result in a TOF estimate about 100 microseconds shorter than a threshold of 0.4 volts. This produces a distance difference of about 0.5 inches between the two estimates.

FIG. 3 illustrates a related threshold issue. The lower envelope 308 measurement is significantly larger in amplitude (the signal actually saturates a little before mid-screen). A 0.3 volt-below-baseline threshold results in a detection much earlier in the overall event than a 0.3 volt-below-baseline threshold for the upper 306 envelope waveform. Thus, a fixed threshold results in a distance estimate that varies with signal amplitude.

For most robot applications, such increased error due to threshold issues is tolerable, since an error of 1 inch or even more is usually acceptable. Thus, the (TOF1+TOF2) quantity in Eqs. 1 and 2, when computed using AM-demodulation will, in most robot applications, suffice.

At first glance, an appropriate way of computing the time-of-flight difference, (TOF−TOF2), might appear to be just subtracting the second AM-demodulated TOF from the first. FIG. 3 illustrates the difficulty in using this method. While the lower envelope 308 leading edge precedes the upper 306 receiver envelope's leading edge by perhaps 100 microseconds or so, its trailing edge actually continues after the waveform's 306 trailing edge. This occurs because the lower waveform 304 is the result of a much larger received signal than the signal associated with the upper 302 waveform. It is an open question whether the ultrasonic receiver associated with the red waveform received its signal before or after the other receiver and by how much.

The TOF difference will typically be a quantity less than 100 microseconds. The uncertainty occurring as the result of threshold choices and the different amplitude magnitudes between the two receivers makes this straightforward approach unacceptable.

One method of improving the difference estimate is to use what is referred to as a parabolic approximation. In this approach, three samples in the detection region are taken for each of the two receiver envelopes, usually one at the leading edge, one near the bottom and one on the trailing edge. The detection “dip” is then approximated by a parabola passing through these three points for each of the two receivers and the location of the minima of the two resulting parabolas are used to compute the TOF difference.

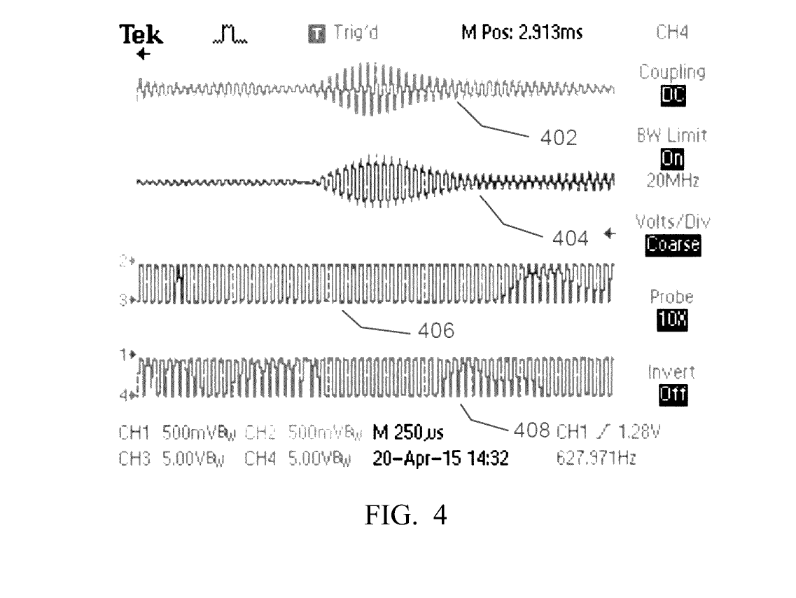

An alternative method for determining TOF difference is to use one or both of the receiver envelope “dips” to indicate that an obstacle reflection is in the region, then use phase difference between the two sides to estimate TOF difference. FIG. 4 shows the waveforms 402 and 404, after amplification, from the two ultrasonic receivers. These two signals are then connected to voltage comparators, producing “squared up” signals 406 and 408.

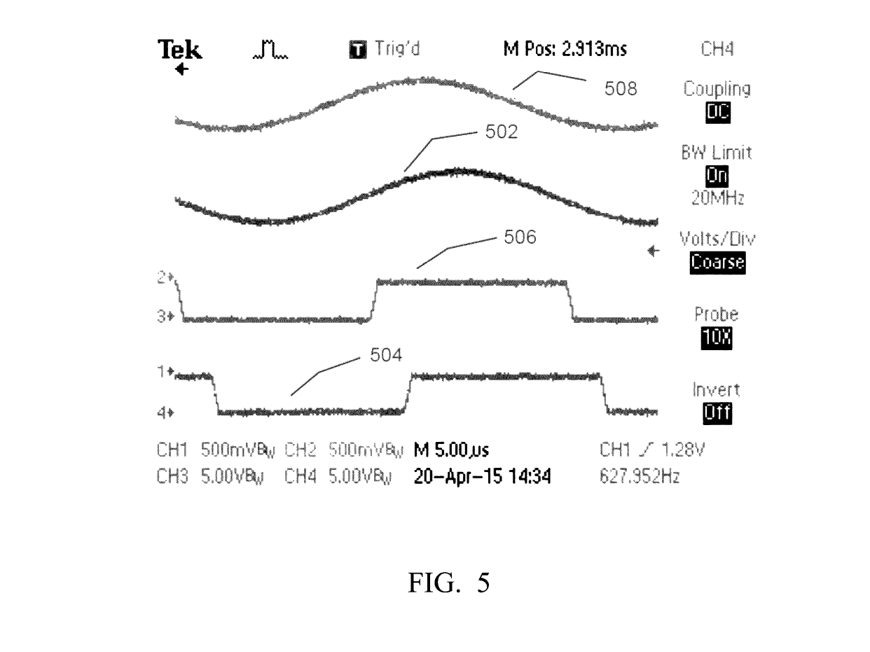

If the time scale is now expanded, so that only about one period of each waveform is shown (FIG. 5), the phase difference becomes obvious—the receiver corresponding to the waveform 502 leads the receiver corresponding to the waveform 504 by about 4 μsec. Using this simple method, we know that (TOF1−TOF2)=4 μsec for this example.

Note on the comparator 506 and comparator 504 output waveforms of FIG. 4 how the waveforms transition to their stable-phase versions before and after the “obstacle event” that is apparent from the increase in amplitude in the waveforms 508 and 502 at about mid screen. The transition is particularly apparent with the waveform 506, which stabilizes at the onset of the event and actually appears to transition back to some random phasing even before the event has completely subsided. This data indicates the need to compare the phase difference near the peak of the event, rather than at the onset, which is the point at which an AM-demodulated envelope threshold detector often announces the event. A way to do this is to simply sample the envelopes of the two receiver signals and observe when their slope changes sign.

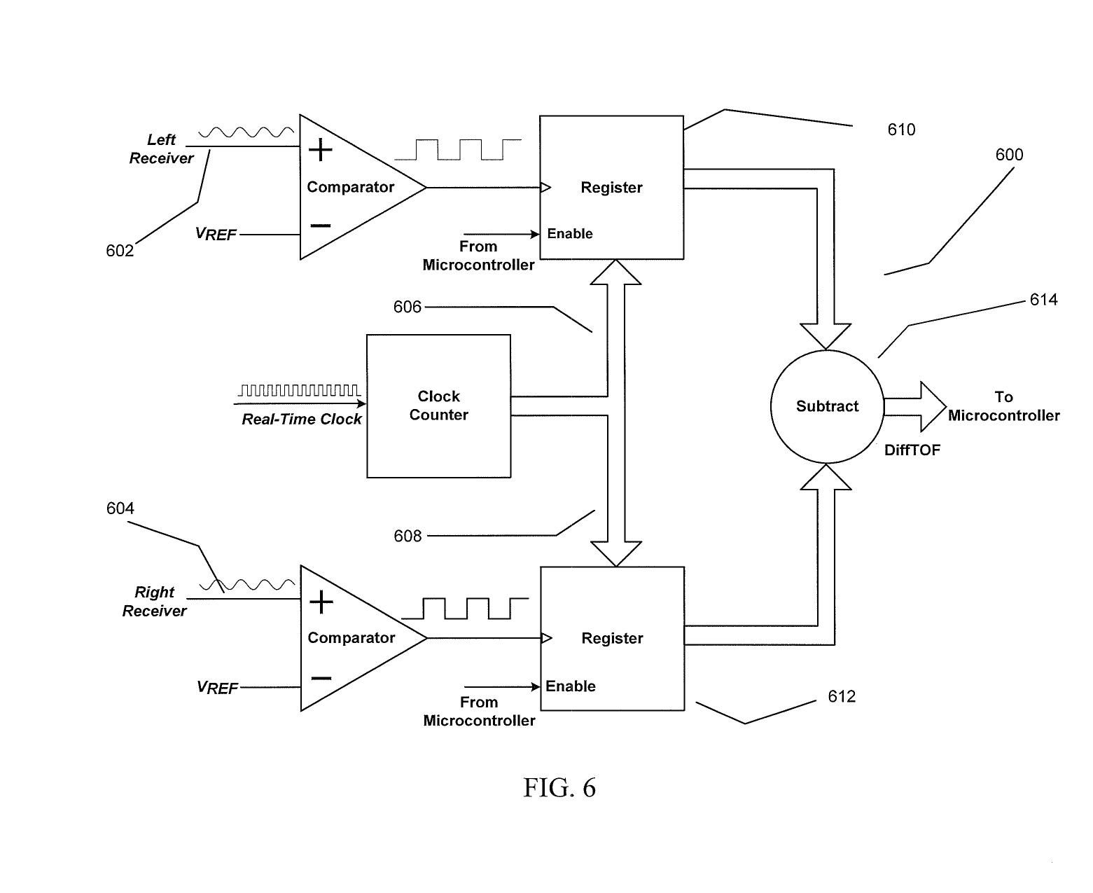

One implementation of the TOF difference hardware 600 can work as shown in FIG. 6. The filtered microphone outputs or piezo-based sensor outputs 602 and 604 are fed to voltage comparators which then drive the clock inputs 606 and 608 of their respective registers 610 and 612. However, the register clock is controlled by a microcontroller which only enables the register clock when the AM demodulated threshold detector has indicated the presence of an obstacle.

Once the enablement occurs, the registers can then capture the time corresponding to the leading edge of the comparators. The “time” that they capture is actually the count from a fixed-frequency counter. The two numbers corresponding to the time are subtracted 614 from one another and, after being divided by the real-time clock frequency, produce the actual time difference between square wave leading edges. This digital number difference is read by the microcontroller which can then use the difference in making the calculations for X and Y (Eqs. 1 and 2).

The sound generated by the transmitter and reflected by the obstacle is attenuated by both absorption in the air and by the spreading of the energy as it travels. Thus, signals reflected from an object nearby (say, 12 inches) are higher than signals from objects far away (for example, 10 feet) by orders of magnitude.

To avoid saturation at short distances, yet have relatively large signals (for example, tens of millivolts) to work with at long distances, a variable gain stage can be inserted in each of the two receiver signal chains. The gain is controlled by the microcontroller and is changed over the course of the echo time to compensate for the attenuation. It is important that both gain stages produce gains that track one another closely. Digital potentiometers work well for performing this function.

As explained previously, it is important that the XY Ultrasonic Ranging Sensor have a wide FOV for short distance obstacles to avoid missing obstacles but have a narrow FOV for long distances to avoid false-alarm detection of obstacles well outside the path of the vehicle.

By way of illustration, if the robot is 8 inches wide (±4 inches), it would be desired to ignore objects that are outside this X=±4 inch expanse since they pose no danger of collision. Perhaps to bias the robot's decision in favor of false alarms rather than missed detections, for one implementation one might choose to make the limit a little larger, for example, ±6 inches.

One thing that could be done to make such a decision about a potential obstacle is to simply perform the computation in Eq. 1 and, in the event that X is larger than the pre-established limit (for example, ±6 inches) discard that set of calculations and go on to the next observed obstacle. The problem with this approach is that Eq. 1 is a floating-point calculation that may take several hundred microseconds for a limited-performance microcontroller to perform. By the time the calculation is completed and determined to represent an out-of-bounds obstacle, some other obstacle's reflection waveforms may have already gone by. If that obstacle is in-bounds, then a missed detection has occurred.

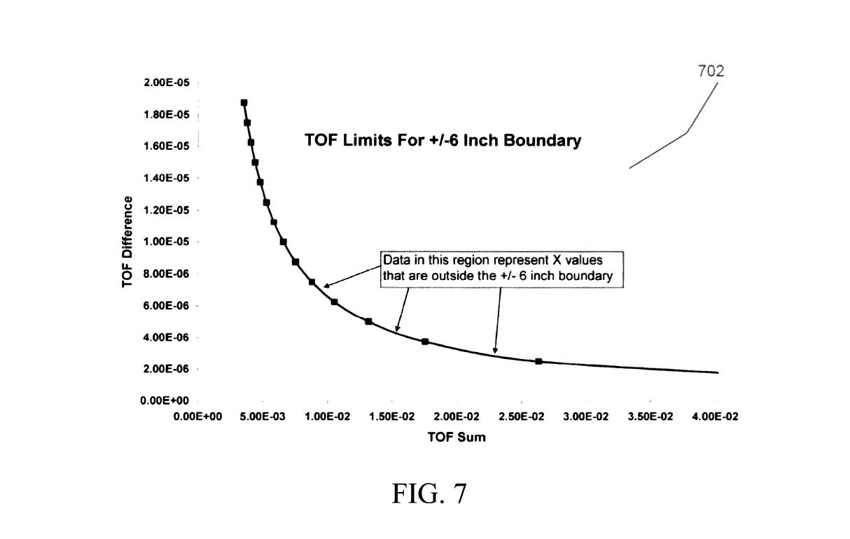

A simple way to remedy this is to use a look-up table that roughly calculates the maximum TOF difference that will be within the path of the vehicle, given the TOF sum. An example is shown in FIG. 7. Here Eq. 1 has been rearranged to give:

$$TOF 1 - TOF 2 = \frac{8 XD}{{c}^{2} ( TOF 1 + TOF 2 )} \qquad ( 4 )$$

Where D=0.25 inches is the spacing between receivers, X=6 inches is the boundary limit for determining what obstacles must be considered, and c is the speed of sound. This equation produces the curve 702 of FIG. 7. The curve is then subdivided into 16 regions, each with approximately 20 μsec/16 spacing between adjacent TOF Difference values. Thus, by taking the TOF Sum and doing a table lookup with the four most significant bits, a rough upper limit for TOF Difference can quickly be established and the potential obstacle quickly discarded or chosen as the nearest obstacle.

One additional improvement that can be made concerns the process of determining Y. One implementation is to make this measurement is to count the number of real-time clock cycles from the beginning of the transmit waveform to the detection of the obstacle using the AM-demodulated received waveform.

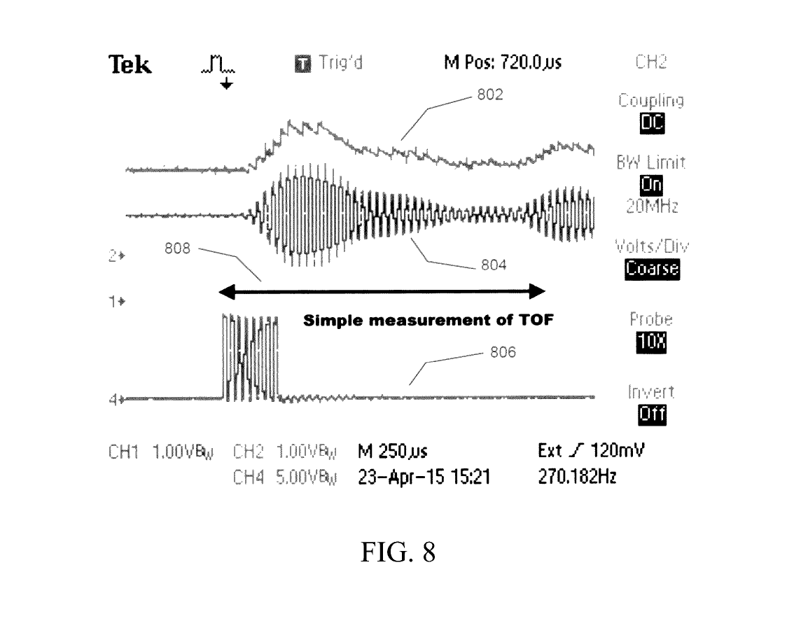

However, both the ultrasonic transmitter and ultrasonic receiver take time to build up their response to the driving and incoming signals, respectively. FIG. 8 shows the transmitter drive waveform 806, along with the received waveform 804 and the demodulated received waveform 802. The arrowed line 808 shows the result of this simple measurement. This simple measurement approach introduces an offset error in the timing, due to the lag in received response.

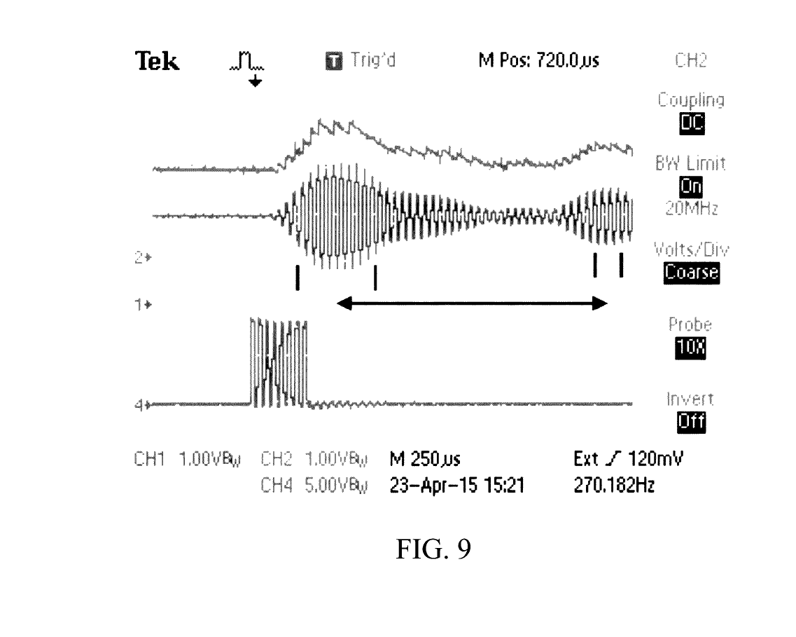

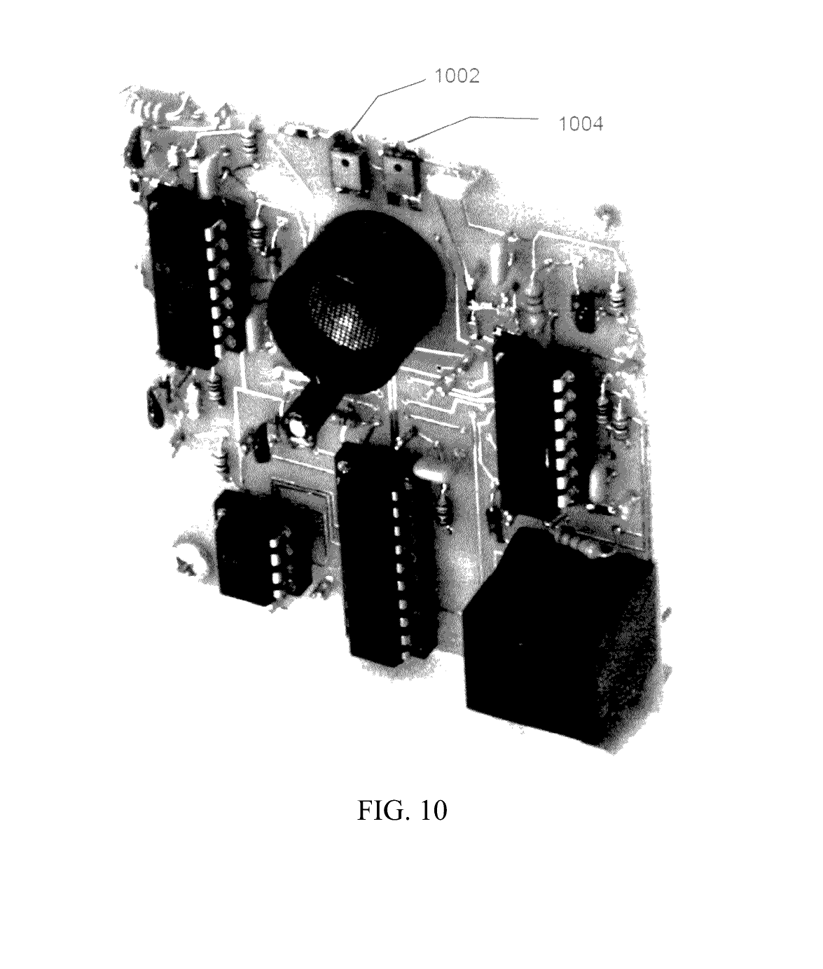

A more accurate measurement can be made by observing the approximate center of the receiver response that immediately follows the transmission and finding the approximate center of the obstacle response and using this time as the measure of the TOF. The more accurate measurement is illustrated in FIG. 9. The implementation of this technology incorporating these aspects of the design is illustrated in FIG. 10. Note the two small microphone receivers 1002 and 1004 located just above the transmitter.

The various implementations of the technology disclose and shown illustrate an apparatus and method for ultrasonic ranging that allows for the determination of both longitudinal and lateral distances therefore, solving the problem of determining how far to the left or right an object is using such a sensing apparatus, and where the range problem can be mitigated by providing variable gain in the receivers, by varying the number of pulses from the transmitter, or by varying the threshold. A user of the present technology may choose any of the above implementation, or an equivalent thereof, depending upon the desired application. In this regard, it is recognized that various forms of the subject ultrasonic range sensors could be utilized without departing from the spirit and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the present invention.

The various implementations and examples shown above illustrate a method and apparatus for range sensors. A user of the present method and system may choose any of the above implementations, or an equivalent thereof, depending upon the desired application. In this regard, it is recognized that various forms of the subject range sensing method and apparatus could be utilized without departing from the spirit and scope of the present implementation.

As is evident from the foregoing description, certain aspects of the present implementation are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the present implementation. Accordingly, the specification and drawings are to be regarded in an illustrative rather than a restrictive sense.

Certain systems, apparatus, applications or processes are described herein as including a number of modules. A module may be a unit of distinct functionality that may be presented in software, hardware, or combinations thereof. When the functionality of a module is performed in any part through software, the module includes a computer-readable medium. The modules may be regarded as being communicatively coupled. The inventive subject matter may be represented in a variety of different implementations of which there are many possible permutations.

The methods described herein do not have to be executed in the order described, or in any particular order. Moreover, various activities described with respect to the methods identified herein can be executed in serial or parallel fashion. In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine or computing device. Further, while only a single machine is illustrated, the term “machine” shall also be taken to include any collection of machines that individually or jointly execute a set (or multiple sets) of instructions to perform any one or more of the methodologies discussed herein.

Computer systems and client computers can include a processor (e.g., a central processing unit (CPU) a graphics processing unit (GPU) or both) for processing the range data captured, a main memory and a static memory, which communicate with each other via a bus. The computer system may further include a video/graphical display unit (e.g., a liquid crystal display (LCD) or a cathode ray tube (CRT)). The computer system and client computing devices also include an alphanumeric input device (e.g., a keyboard), a cursor control device (e.g., a mouse), a drive unit, a signal generation device (e.g., a speaker) and a network interface device. A computing system can process and analyze the range data and issue control signals responsive to the receive range data.

The drive unit includes a computer-readable medium on which is stored one or more sets of instructions (e.g., software) embodying any one or more of the methodologies or systems described herein. The software may also reside, completely or at least partially, within the main memory and/or within the processor during execution thereof by the computer system, the main memory and the processor also constituting computer-readable media. The software may further be transmitted or received over a network via the network interface device. The software can process the algorithms to calculate range based on received range data and calculate guidance path to avoid any detected obstacles.

The term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing or encoding a set of instructions for execution by the machine and that cause the machine to perform any one or more of the methodologies of the present implementation. The term “computer-readable medium” shall accordingly be taken to include, but not be limited to, solid-state memories, and optical media, and magnetic media.

What is claimed is:

1. An apparatus for longitudinal and lateral ultrasonic ranging comprising:
a first and second ultrasonic receiver spaced laterally on either side of an ultrasonic transmitter an equidistant, where the first and second ultrasonic receivers respectively have a first and second variable gain control and have an amplitude-modulation demodulator configured to generate a first and second amplitude-modulation envelope of a first and second response for the first and second ultrasonic receivers;
an amplitude-modulation demodulator envelope threshold detector configured to detect a first and second time when the first and second amplitude-modulation envelopes exceed a threshold indicative of the presence of an object;
a subtraction module configured to calculate a time difference between the first and second times; and
microcontroller configured to control the first and second variable gain controls to track a first and second gain of the first and second ultrasonic receivers over the time difference to compensate for attenuation.

2. The apparatus as recited in claim 1, where the first and second ultrasonic receivers are piezo receivers.

3. The apparatus as recited in claim 1, where the ultrasonic transmitter is a piezo receiver.

4. The apparatus as recited in claim 1, where the first and second ultrasonic receivers are microphones.

5. The apparatus as recited in claim 4, where the microphones include band-pass filters.

6. The apparatus as recited in claim 1, where the first and second variable gain controls comprise:
a first and second digital potentiometer configured in cascade with the first and second ultrasonic receivers respectively, where the first and second digital potentiometers are controlled by the microcontroller to decrease the threshold as the time difference is increasing.

7. The apparatus as recited in claim 1, where the subtraction module is configured to utilize a parabolic function to sample the first and second amplitude-modulation envelopes to compute the time difference between the first and second times.

8. A method for determining longitudinal and lateral ultrasonic range comprising:
receiving a reflected ultrasonic signal at a first and second ultrasonic receiver spaced laterally on either side of an ultrasonic transmitter an equidistant;
generating a first and second amplitude modulation envelopes for the first and second ultrasonic receivers respectively;
variably controlling the gain of the first and second ultrasonic receivers respectively with a first and second gain control;
generating first and second amplitude modulation envelopes of a first and second response for the first and second ultrasonic receivers with an amplitude-modulation demodulator;
detecting when the first and second amplitude-modulation envelope exceeds a threshold with a threshold detector, indicative of the presence of an object;
calculating a time difference between the first and second times with a subtraction module; and
controlling with a microcontroller the first and second variable gain controls to track a first and second gain of the first and second ultrasonic receivers over the time difference to compensate for attenuation.

9. The method as recited in claim 8, where the first and second ultrasonic receivers are piezo receivers.

10. The method as recited in claim 8, where the ultrasonic transmitter is a piezo receiver.

11. The method as recited in claim 8, where the first and second ultrasonic receivers are microphones.

12. The method as recited in claim 11, where the microphones include band-pass filters.

13. The method as recited in claim 8, further comprising:
decreasing the threshold as the time difference is increasing with a first and second digital potentiometer configured in cascade with the first and second ultrasonic receivers respectively, where the first and second digital potentiometers are controlled by the microcontroller.

14. The method as recited in claim 8, where the subtraction module is configured to utilize a parabolic function to sample the first and second amplitude-modulation envelopes to compute the time difference between the first and second times.
